(19) United States
(12) Patent Application Publication
(10) Pub. No.: US 2014/0257954 A1
(43) Pub. Date: Sep. 11, 2014

(54) Goal-Oriented Long Term Incentive Award Education System

(71) Applicant: Jie Tan, Tarrytown, NY (US)

(72) Inventor: Jie Tan, Tarrytown, NY (US)

(21) Appl. No.: 13/927,070

(22) Filed: Jun. 25, 2013

Related U.S. Application Data
(63) Continuation-in-part of application No. 13/784,943, filed on Mar. 5, 2013.

(51) Int. Cl. G06Q 30/02

(52) U.S. Cl. CPC G06Q 30/0215
USPC 705/14.17

(57) ABSTRACT

A long term goal oriented incentive learning and feedback award system is disclosed. A kid user, parent, a school, a charity and/or a program provider are enabled to directly interact to provide financial incentives to the kid user to be motivated in a program. A parent, a school, a charity and/or a program provider are also enabled to define any task or content on the system. A kid user is enabled to set up a monetary holding account on the system to accumulate the financial incentives under a long term goal. A charity is enabled to provide direct financial support to any programs registered on the system.

### CROSS-REFERENCE

This application is a continuation-in-part to the U.S. application Ser. No. 13/784,943, filed on Mar. 5, 2013, from which priority is claimed, and the entirety of which is hereby incorporated by reference.

### DESCRIPTION OF RELATED ART

The present application relates to a web-based education management interactive system on the internet and on the wireless mobile network system for providing goal oriented incentive programs for learning, feedbacks and surveys for kids, parents, schools, charities and content providers. More particularly, the present application relates to an electronic internet system and/or a mobile device application that is provided to allow kids to earn real financial incentives by performing a task on the system from various sources and to enable a kid to combine and accumulate monetary incentives for a specific goal.

Note that the points discussed below may reflect the hindsight gained from the disclosed inventions, and are not necessarily admitted to be prior art.

Psychologists used to warn that money could make kids perform worse by cheapening the act of learning. Parents predict widespread slacking after the incentives go away. The conventional solutions for the education system thus have been avoiding direct cash incentives and have been focused on finding the incentives that promote the inner desire of a kid to learn. Researchers have found that smaller classes or teachers being creative in teaching are of positive effects. However, the suggested solutions have made the education system unbearably expensive and the final results are not satisfactory to all.

On the other hand, to many inner city children, simply reducing class sizes does not play the magic of increasing kids' motivation to learn. As the education system becomes more and more expensive, it appears none of the tried various reforms have much of the effect.

The conventional solutions are based on one fatal presumption, that all kids know what to learn and are not tempted by other worldly temptations. While this is hard for adults to do, we seem to expect that our kids would somehow not be tempted by worldly interests. Another naïve part of the theory is to assume that all kids are as if living in an isolated innocent vacuum, with an uncultivated desire to learn, and which is simply waiting to be cultivated with an interesting teacher.

While it is natural for kids to learn new things, whether all kids desire with an inner drive to learn new things is not as evident as people would like to admit. Dr. Roland G. Fryer's research in Harvard Education Innovation Lab shows that cash award, as it is to adults, is in fact a very powerful incentive to induce school kids to do things that they may be otherwise lack of initial interests or motivations.

However, some of the trial programs of Dr. Roland G. Fryer's research failed. The failed programs show that for children to make proper progress in learning, cash incentives or motivations alone are not sufficient, detailed instructions as to how to achieve a learning goal and what are the steps must be properly administered and instructed. Programs where kids did not know how to achieve the required goals, even though they were very much excited and wanted to achieve the goals, failed. Therefore for the cash-based incentives to function properly, careful instructions must be given, that is, tasks must be given with as much details as possible. Complicated tasks must be given in a series of simple tasks in a step by step manner.

The levels of details thus require a large amount of man hours and laborious monitoring of the progresses. It is understandably very hard to achieve with limited number of teachers in school classes who cannot monitor each of the steps that one specific kid may need to take and to be motivated to reach the next level.

Monitoring and managing tasks to the most detailed levels are the advantages that a computer system can provide with minimum cost. A task program can be designed with as much details as possible with a few combinations of clicks and can be applied to many similar kids repetitively. A computer system that allows the participation of parents also alleviates the burdens of teachers to have to motivate each and every child in his or her class. Private charities can also use such system to directly sponsor or finance a kid's motivation without incurring much increase in management burden to the charity.

Thus there is a great need for such network based task management computer system that provides the combined motivations of real money based incentives and the willingness for retaining accepted goals by kids to perform and learn in supplementing the current education system.

### SUMMARY

A task management interactive computer platform for education is disclosed. The system is designed to education content open in that various content can be adopted from various providers so that an unlimited amount of content programs are available for any kid to search and find to initiate a special interest in learning. The system with built-in databases would automatically collect data and provide the much needed feedbacks instantly and timely to educators, parents, charities and any other content providers to help design the next program or steps of the tasks. The system would allow a kid to set up a holding account and allow each financial award to accumulate in such a holding account towards achieving a particular pre-set or adopted goal. Therefore the computer system in this application motivates a child to learn and perform a task by both cash incentives and the internal desires and goal driven motivations.

The computer system can be made self-sustainable based on the business model of credit cards, that each of the cash award transactions can be charged with a small broker fee for the system to provide the management services and searchable educational contents.

In one embodiment, the system includes a search engine for searching available programs, a children center as exchange platforms for kids to communicate with peers, and a parent center for parents to provide incentive programs, a school center for educators to manage its programs and accounts, a charity center for charities to provide support to content programs, schools or parent groups, and a program center for content providers to provide sponsored incentive programs, education materials and tasks. The system may also have a goal center for kids or parents to set up goals to be linked with a holding account of a kid.

In one embodiment, at children center, a kid user can search for available incentive providing programs, can register to set up an account, and can browse through the most popular programs on the system, and can review the top 10 performers of the newcomers of the last week, and browse and join an activity group.

In one aspect of an embodiment, once a child is registered, he/she can set up a holding account, review current holding accounts, set a long term goal and link a goal to a holding account. The holding account is allowed to accumulate money and grow its money balance with more transactions. The long term goals may include paying college educations or retirement, financing a vacation, providing seed money for starting a business, and paying for patenting innovative ideas, etc.

In one aspect of an embodiment, a communication center for child center is built into a child login function, where a child can post a question to a peer or a teacher or a program administrator; send a feedback to a program or school, and finish a survey about a program. A registered child is also enabled to search incentive providing programs offered locally on the system, by key words, by personal information, and by incentive amount or by the most recent offers; and is enabled to enter such programs with a single click.

In one embodiment, at parent center, a parent user can search for available incentive providing programs, can register to set up an account, and can browse through the most popular programs on the system, and can review the top 10 most recent programs, can review a local list of parent groups and can join a parent group and use the communication center.

In one aspect of an embodiment, once a parent is registered, he/she can set up a holding account, review current holding accounts, set up a program/task, link a task or a program to a holding account, review a program's statistics and history, and accept support from a charity. The holding account may be activated with a deposit of money. Setting up a program includes providing the required satisfactory performance criteria. A registered parent can also set up an incentive program or task, and either keep it private or make it available to the public or keep the access restricted to a specific group of children.

In one aspect of an embodiment, a communication center for parent center is built into a parent login function, where a parent can post a question to a parent group or a teacher or a program administrator; send a feedback to a program provider or school or charities, and finish a survey about a program, and send inquiries to a charity, or communicate to a child. A registered parent is also enabled to search incentive providing programs offered locally on the system, by key words, by personal information, by incentive amount or by the most recent offers; a parent user may be enabled to enter such programs with a single click.

In one embodiment, at charity center, a charity user can search for available incentive providing programs, can register to set up an account, and can browse through the most popular programs on the system, can review the top 10 most recent programs, can review a list of charities registered on the system and can provide direct support for a parent group without register and also use the communication center to communicate to programs providers without registration.

In one aspect of an embodiment, once a charity is registered, it can set up a holding account, review current holding accounts, link a task or a program to a holding account, review a program's statistics and history and provide support to a group. The holding account may be activated with a deposit of money. Setting up a program includes providing the required satisfactory performance criteria. A registered charity can also view a list of available programs that are made available to a particular charity.

In one aspect of an embodiment, a communication center for charity center is built into a charity login function, where a charity can post a question to a parent group or a teacher or a program administrator; receive a feedback to a program or send an inquiry to a school or other charities, and provide a survey to registered children or parents or schools.

In one embodiment, at school center, a school user can search for available incentive providing programs, register to set up an account, and can browse through the most popular programs on the system, and review the top 10 most recent programs, view a list of parent groups without register and also use the communication center to communicate to programs providers or parent groups without registration.

In one aspect of an embodiment, once a school is registered, it can set up a holding account, review current holding accounts, link a task or a program to a holding account and review a program's statistics and history and accept a charity support. The holding account may be activated with a deposit of money. Setting up a program includes specifying the criteria required for satisfactory performance. A registered school can also view associated children groups, or set up children groups for a child to join.

In one aspect of an embodiment, a communication center for school center is built into a school login function, where a school can post a question or instruction to a parent group or a children group, or to a program administrator; receive a feedback to a program or send an inquiry to charities, and provide and receive a survey to and from registered children or parents.

In one embodiment, at program center, a program provider can register to set up an account, and publish a program, and create a program or import statistics of a program.

In one aspect of an embodiment, once a program provider is registered, it can set up a holding account to provide financial incentives and to receive payment for content, review current holding accounts, link a task or a program to a holding account and review a program's statistics and history and accept a charity support. The holding account may be activated with a deposit of money. Setting up a program includes specifying the criteria required for satisfactory performance. A registered program provider can also view associated schools, and charities that are using or supporting the program.

In one aspect of an embodiment, a communication center for program center is built into a program provider login function, where a school can post a question or suggestion, or a program administrator can receive a feedback to a program or send an inquiry to charities, and provide and receive a survey to and from registered children or parents.

The disclosed innovation, in various embodiments, provides one or more of at least the listed advantages. However, not all of these advantages result from every one of the innovations disclosed, and this list of advantages does not limit the various claimed inventions.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 schematically shows an example set of functional components for a Goal-oriented Incentive Learning and Feedback Award System (GOILAS) in accordance with this application.

FIG. 2 schematically shows an example set of functions in a children center in accordance with this application.

FIG. 3 schematically shows an example set of functions in a children login function in accordance with this application.

FIG. 4 schematically shows an example set of functions in a parent center in accordance with this application.

FIG. 5 schematically shows an example set of functions in a parent login function in accordance with this application.

FIG. 6 schematically shows an example set of functions in a setting up a program function in a parent login in accordance with this application.

FIG. 7 schematically shows an example set of functions in a charity center in accordance with this application.

FIG. 8 schematically shows an example set of functions in a charity login function in accordance with this application.

FIG. 9 schematically shows an example set of functions in a setting up a program function in a charity login or a school login in accordance with this application.

FIG. 10 schematically shows an example set of functions in a view statistics of a program function in charity login function in accordance with this application.

FIG. 11 schematically shows an example set of functions in a school center in accordance with this application.

FIG. 12 schematically shows an example set of functions in a school login function in accordance with this application.

FIG. 13 schematically shows an example of “search a program” function in accordance with this application.

FIG. 14 schematically shows an example set of functions in a program management center in accordance with this application.

FIG. 15 schematically shows an example set of functions in a program provider login function in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The present invention may be described herein in terms of functional block components and various processing steps in an electronic network and devices. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, Java, COBOL, assembler, PERL, Python or the like, and other necessary computer coding languages, with the various algorithms being implemented with any combination of data structures, objects, processes, routines, or other programming elements. Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Furthermore, the connecting lines shown in the various figures contained herein are intended to represent exemplary functional relationships and/or physical couplings between the various elements. It should be noted that many alternative or additional functional relationships or physical connections may be present in a practical incentive system implemented in accordance with the invention.

A “component or function” term represents physical replacement part of the system that conforms to and provides a realization through a set of interfaces. It also includes automated software interfaces that comprise source files, binary code, executables, scripts that are packaged for performing the intended functions.

A “system” term represents a combination of a package and binary codes with the necessary hardware for the execution thereof. The package contains all the elements, including unique elements, models, source files, html files, etc. that realizes these interfaces to the one unique package.

An “engine” term in this application means a computer functional modular having a set of instructions programmed to complete a specific task, solve a problem, by instructing a computer processor.

A “web-service” term means an application layer service that executes via a public internet interface and doesn't necessarily imply to be a web site. A web service is one that can be located, discovered, and published via a network channel. Additionally, a web service can also act as an intermediary business application service agent that is an encapsulated service provider, but can also be a service requestor.

For “network services”, there are two types. One type of “network services” mean file sharing services, file services, collaboration services, and messaging. They can also be located, discovered, and published. Another type of network service, taking the form of a Network Interface, implements a standard connection protocol, such as Ethernet, Wireless, etc. “Service” may mean either a Network Service and/or Web Service.

A “program provider” include content providing individuals, parents, content providing corporations, government, charities, schools and any other organizations or persons that provide or register a content program on this computer system.

A “content” or “program” or “task” is a specially designed task or educational material or a game that a child is required to learn or perform that is linked with a financial incentive offered by various program providers. Example list of content may include home works, house chores, scouts projects, study materials, school materials, school projects, competitions, online contents provided by various software entities, and/or any other youth activity related materials that are offered or targeted to youth.

A “user” in this application includes any user that uses the system, it may be a child, a parent, a teacher, a charity employee, or any other web browsing people.

It is contemplated and intended that the disclosed system and methods, interfaces and functions are for use on any network devices, both from the internet networked computer terminal and for the mobile devices, PDAs and cell phones and any other network capable devices.

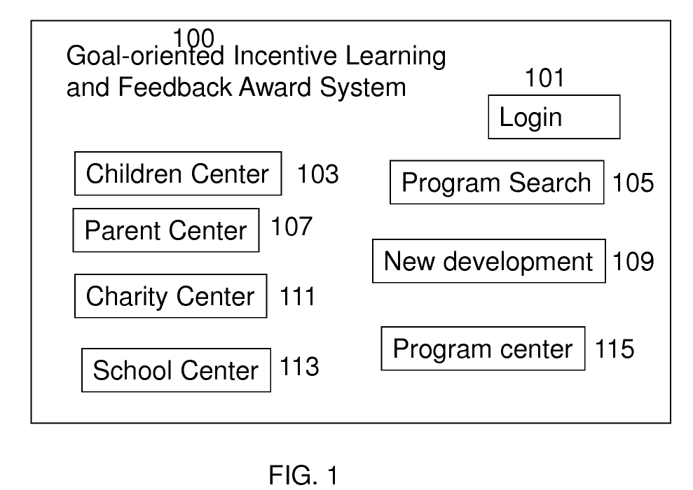

In reference to FIG. 1, a Goal-oriented Incentive Learning and Feedback Award System (GOILAS) 100 includes several major interfaces: a direct login component 101 for any user from the home page of the system; children center 103 for accessing functions related with child users, parent center 107 for accessing functions related with parent users, charity center 111 for accessing functions related with charity users, school center 113 for accessing functions related with educator users, program center 115 for accessing functions related with content provider users, content program search 105 for accessing functions related with searching for incentive providing content programs, news of new development of the system 109 for accessing news of new development of the system.

These interface components will interact with the various backend components or functions, such as: Search Engine component, various Databases, and Transaction Engine that includes a Provider Management component and a User Management component. These various functions and components are described in detail in the U.S. application Ser. No. 13/784,943, filed on Mar. 5, 2013, the entire content of which are therefore incorporated by reference. The Provider Management component provides management functions over content Provider Account Database and the Conditional Award Program database. User Management component provides management functions to various User Account Databases.

A program provider (for example, a parent, a teachers, a charity, an organizer for an activity or competition) generally sets up a Conditional Award program with the GOILAS system that includes a performance requirement on its own service site or on the GOILAS system under the Conditional Award Program ID. This requirement is generally linked with a Provider's User Performance Page on the Provider's service site, or created on GOILAS system if the provider does not operate an internet site. The User Performance Page details about the content and data that the Provider is requiring a kid user to perform, for example, a set of house chores required by a parent, a set of home work required by a teacher, competition practices by a competition organizer, etc.

Once a kid user performs and submits its performance result from the User Performance Page, the User Performance Page at the Provider site inquires the GOILAS about the kid user's registration status and verifies from its User Account Database. Once the kid user's User ID is validated, either the GOILAS system, or alternatively, the Provider's User Performance Page (by manual checking or automatic checking) checks whether the kid user has performed as required, and if it is yes, the performance result is used to calculate an award according the set up of the program by using the Award Program ID and the program specification. Then the Program ID, Provider ID, and the kid user's User ID are used to access the User management engine and to authorize the transfer of the calculated real money award amount from the linked program provider's holding account to the kid user's holding account.

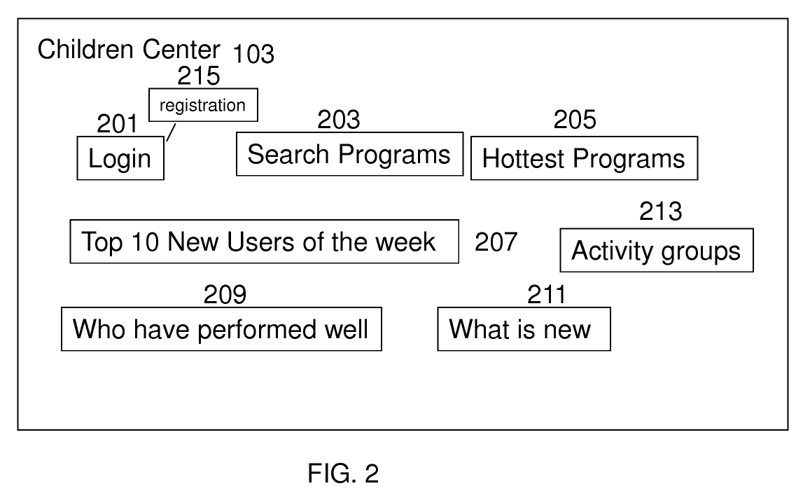

In reference to FIG. 2, an example children center 103 is shown. The children center is for the interaction of kids or youth users with the system. Children center 103 at least includes several user interfaces: login component 201, “program search” component 203, “the most popular programs” component 205, “the top 10 new users” of the week component 207, the list of “who have performed well” button 209, “what is new” button 211, and “activity groups” among the registered kid or youth users 213.

Login component 201 is also associated with the register button 215, if a user is not registered, he/she will be asked whether to want to be registered. “Program search” component 203 allows a kid user to search for incentive providing contents for review. The “most popular programs” component 205 provides a dynamically updated list of most popular programs, according to different categories or geographic areas. The “top 10 new users” of the week component 207 lists the newly registered kid users who have performed top 10% for the week. “Who have performed well” component 209 provides a list of children who have done well at the moment of checking. “What is new” component 211 provides any news about the children center or any announcement related to children activities. “Activity groups” component 213 provides a list of activity groups among the registered kid or youth users.

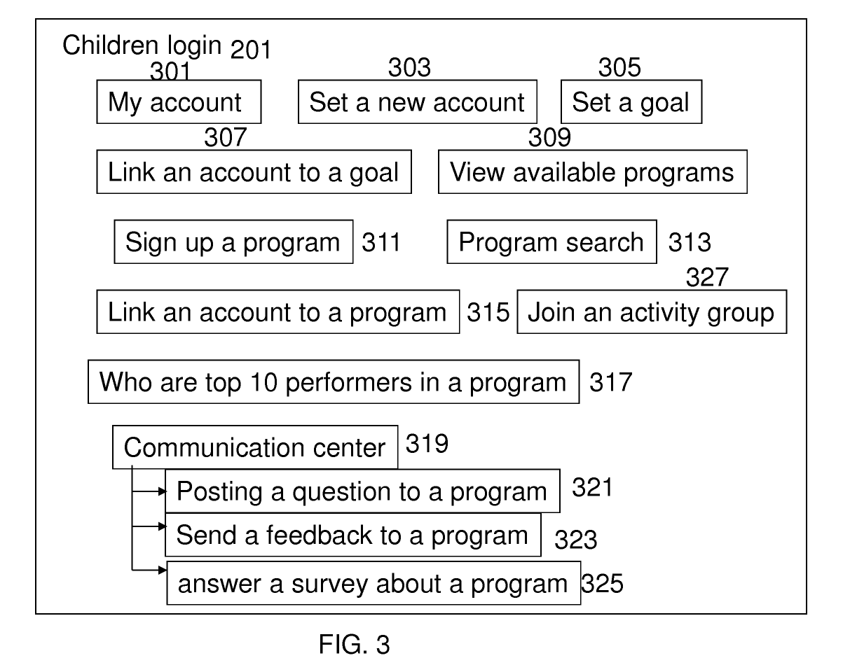

In reference to FIG. 3, an example children login page 201 interface is shown. A variety of functions are accessible through children login component 201. For example, my account component 301, “set a new account” component 303, “set a goal” component 305, “link an account to a goal” component 307, “view available programs” component 309, “sign up with a program” component 311, “program search” component 313, “link an account to a program” component 315, “who are top 10 performers” in a program component 317, a communication center 319 and “join an activity group” component 327.

Through my account component 301, a registered kid or youth can review his/her current balances of his holding account(s) already set up in the system, to check how far the balances are to reach the goal(s) or how much time left for a holding account to reach its associated goal. He/she could also change the linked goals, redeem the account by paying a penalty or review the account histories. A kid user can also set up another account using the “set a new account” component 303, which allows him/her to set up a new holding account for receiving financial awards by performing a program. A kid user can also specify and define a new goal by using the “set a goal” component 305, and then link the new goal to either an existing account or a newly established account using the “link an account to a goal” component 307.

A kid user can view specially made available programs that limit the access to some kid users by using the “view available programs” component 309. A kid user can sign up the access of a program by using the “sign up with a program” component 311, can search for particularly contented programs through keyword search by using the “program search” component 313, and can link a hold account to a program to receive financial award by using the “link an account to a program” component 315.

A kid user may view who are the top 10 performers in a particular program by tying in a program ID with the “who are top 10 performers” in a program component 317, and use the communication center 319 to post a question to a particular program (321), to send a feedback to a program (323) or answer a survey about a program (325). A kid user can join an activity group by using the “join an activity group” component 327. An activity group may be set up by a school or a parent. The “join an activity group” component 327 allows a user to search and find a particular activity group in the system.

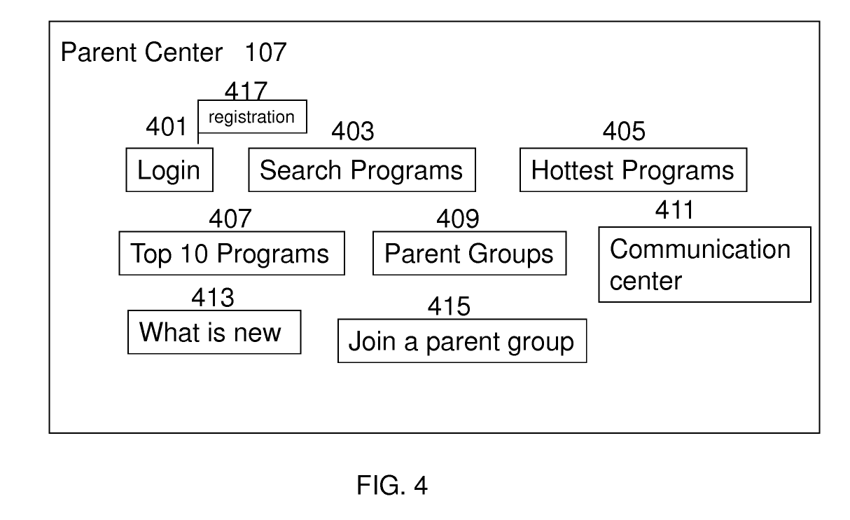

In reference to FIG. 4, an example parent center 107 is shown. The parent center is for the interaction of parent users with the system. Parent center 107 at least includes several user interfaces: login component 401, “program search” component 403, the “most popular programs” component 405, “the top 10 most popular programs” component 407, “parent groups” component 409, “what is new” button 413, and “join a parent group” component 415, and a communication center 411.

Login component 401 is also associated with the register button 417 if a user is not registered, he/she will be asked whether want to be registered. “Program search” component 403 allows a parent user to search for content providing programs for review or for adopting. The “most popular programs” component 405 provides a dynamically updated list of most popular programs of the week or over a period of time, according to several different categories or geographic areas. The “top 10 most popular programs” component 407 provides the “most popular top 10 programs” at the moment of reviewing. The “parent groups” component 409 provides a list of parent groups according to various interest and geographic areas. “What is new” button 413 provides any news about the parent center or any announcement related to parent group activities. The “join a parent group” component 415 allows a parent user to search, select and join a parent group. The communication center 411 allows a parent user to communicate with other parent users, kid groups, schools, charities or content providers.

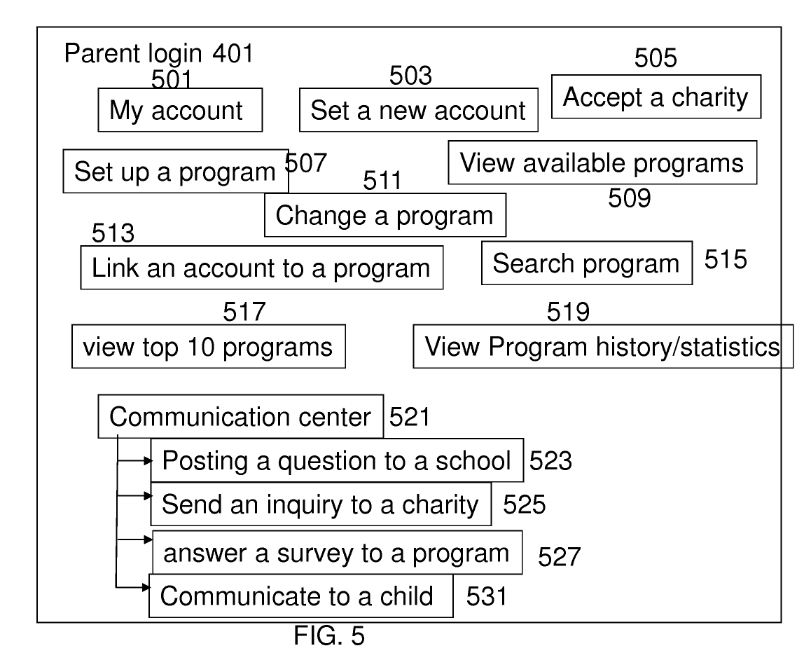

In reference to FIG. 5, an example parent login page 401 interface is shown. A variety of functions are accessible through parent login component 401. For example, my account component 501, “set a new account” component 503, “accept a charity” component 505, “set up a program” component 507, “link an account to a program” component 513, “view available programs” component 509, “change a program” component 511, “program search” component 515, “view top 10 programs” component 517, a communication center 521 and “view program history and statistics” component 519.

Through my account component 501, a registered parent user can review his/her current balances of his holding account(s) already set up in the system, to check the statistics of the linked programs. He/she could also change or modify the linked programs, or review the account histories. A parent user can also set up another account using the “set a new account” component 503, which allows him/her to set up a new holding account for providing financial awards for a kid user for performing a program. A parent user can also accept the financial support from a charity by using “accept a charity” component 505, where a parent user can participate in providing a program that is supported by a charity and accept a charity's financial support.

A registered parent can set up a new program/task for a particular kid and providing financial incentives for the kid to perform this program by using the “set up a program” component 507, and link a program/task to a holding account for automatic financial award management by using the “link an account to a program” component 513. A registered parent may view available programs that are made available by other parents in a parent group or by a school by using the “view available programs” component 509. A registered parent can edit or modify a signed up program by using the “change a program” component 511, where the parent user may modify the program according to his or her kid's need or progress, or modify amount or manner that the kid will get awarded for performing the program.

A registered parent user can also search the system or the internet for finding interested content and education materials to adopt into a financial incentive linked program by using the “program search” component 515, or by using the “view top 10 programs” component 517 where the top 10 most popular programs at the time and location or in a specific area can be viewed instantly.

A registered parent user can use the communication center 521 to post a question to a particular program provider or a school (523), to send an inquiry to a charity for financial support or suggestions (525) or answer a survey about a program of a school (527) or leave a message to a kid user (531). A registered parent user reviews a program history and statistics by using the “view program history and statistics” component 519.

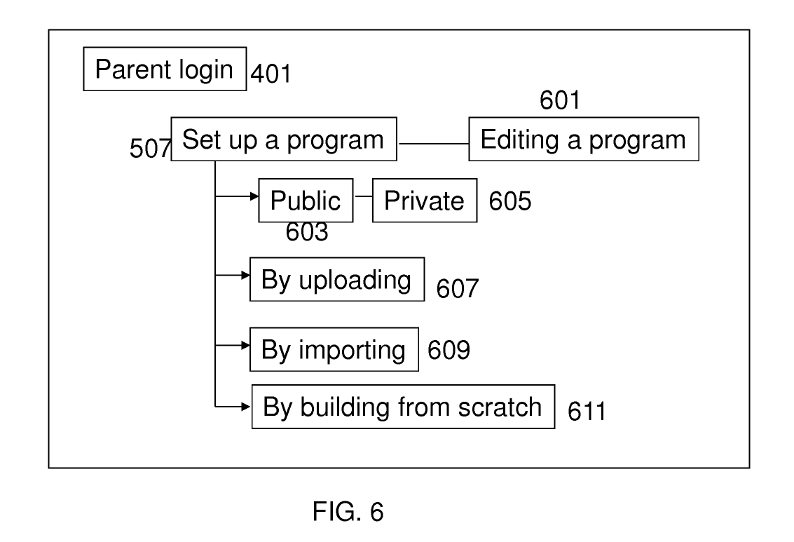

In reference to FIG. 6, an example “set up a program” component 507 for the parent center is shown. By using this function, a registered parent user can edit an existing program (601), and set a program as private (605) which only permits the access of authorized users, or as public (603) which allows the program to be searchable and adoptable by other parents or users on the system. A registered parent user can set up a program content by uploading to the system a pre-made program (607), by importing a program from an online web-site (609) or by building a program from scratch on the system (611).

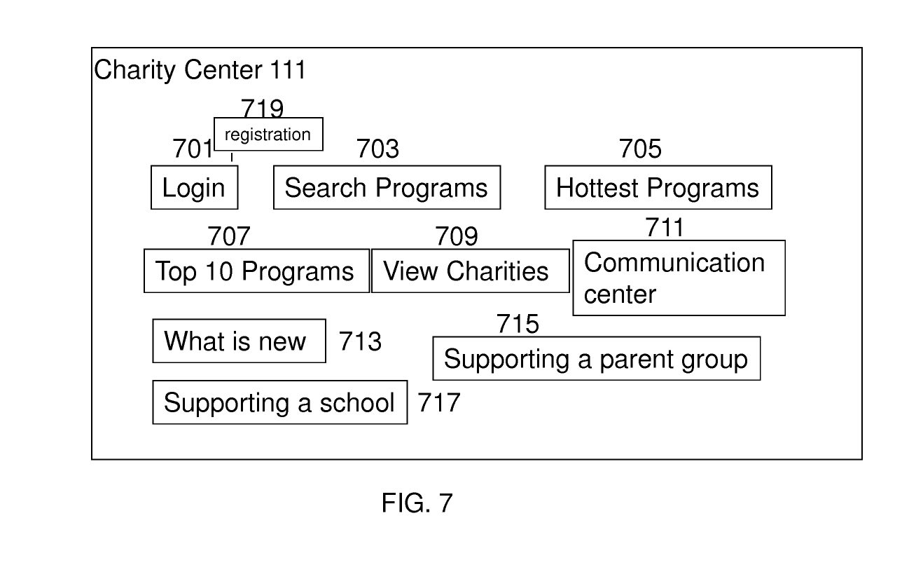

In reference to FIG. 7, an example charity center 111 is shown. The charity center is for the interaction of charity users with the system. Charity center 111 at least includes several user interfaces, for example: login component 701, “program search” component 703, “the most popular programs” component 705, “the top 10 most popular programs” component 707, “view charities” component 709, “what is new” button 713, and “supporting a parent group” component 715, and “supporting a school” component 717.

Login component 701 is also associated with the register button 719 if a charity is not registered, the charity will be asked whether to want to be registered. “Program search” component 703 allows a charity user to search for content providing programs for review or for supporting. The “most popular programs” component 705 provides a dynamically updated list of most popular programs of the week or over a period of time, according to several different categories or geographic areas. The “top 10 most popular programs” component 707 provides the most popular top 10 programs at the moment of reviewing. The “view charities” component 709 provides a list of registered charities according to various interest or specialties and geographic areas. “What is new” button 713 provides any news about the charity center or any announcement related to charity activities.

The “supporting a parent group” component 715 allows a charity to adopt and financially support the content programs provided by the parent users in a parent group, and the “supporting a school” component 717 allows a charity to adopt and financially support the content programs provided by a school.

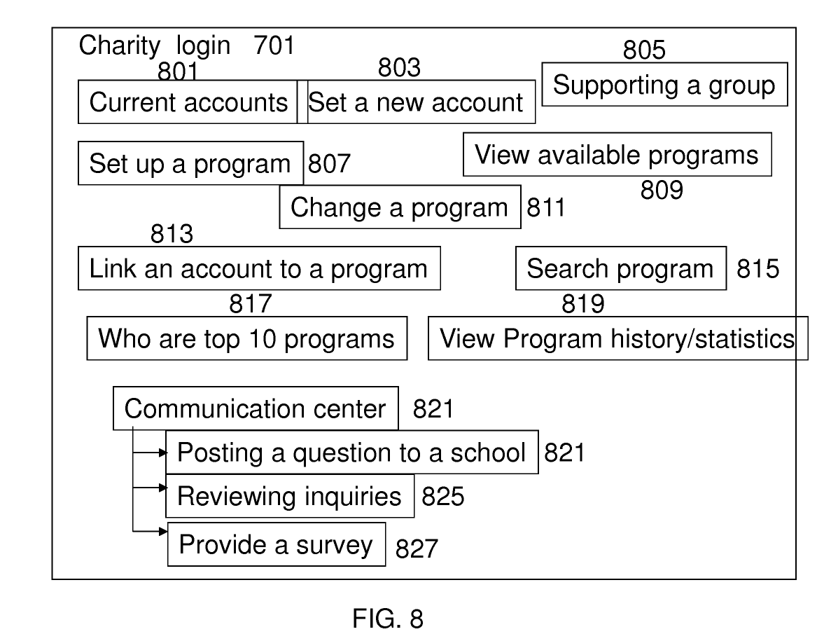

In reference to FIG. 8, an example charity login page 701 interface is shown. A variety of functions are accessible through parent login component 701. For example, my account component 801, “set a new account” component 803, “supporting a group” component 805, “set up a program” component 807, “link an account to a program” component 813, “view available programs” component 809, “change a program” component 811, “program search” component 815, “view top 10 programs” component 817, a communication center 821 and “view program history and statistics” component 819.

Through my account component 801, a registered charity user can review its current balances of its holding account(s) already set up in the system, and to check the statistics of the linked programs. The charity could also change or modify the account, or review the account histories. A charity user can also set up another account using the “set a new account” component 803, which allows it to set up a new holding account for providing financial awards for a group or a kid user for performing a program. A charity user can also adopt and provide the financial support to a parent group or a kid activity group or a school by using the “supporting a group” component 805.

A registered charity can also set up a new program/task for a particular group of kids and providing financial incentives for the kids to perform this program by using the “set up a program” component 807, and link a program/task to a financial holding account for automatic financial award management by using the “link an account to a program” component 813. A registered charity may view available programs that are made available by other parents or by a school by using the “view available programs” component 809. A registered charity can edit or modify a signed up program by using the “change a program” component 811, where the charity user may modify the program according to its needs or a kid group's needs, or modify the amount or the manner that the kids will get awarded for performing the program.

A registered charity user can also search the system or the internet for finding interested content and education materials to adopt into a financial incentive linked program by using the “program search” component 815, or by using the “view top 10 programs” component 817 where the top 10 most popular programs at the time and location or in a specific area can be viewed instantly.

A registered charity user can use the communication center 821 to post a question to a particular program provider or a school (823), to receive and review an inquiry (825) or provide and receive a survey about a program or about a school (827). A registered charity user can review a program history and statistics by using the “view program history and statistics” component 819.

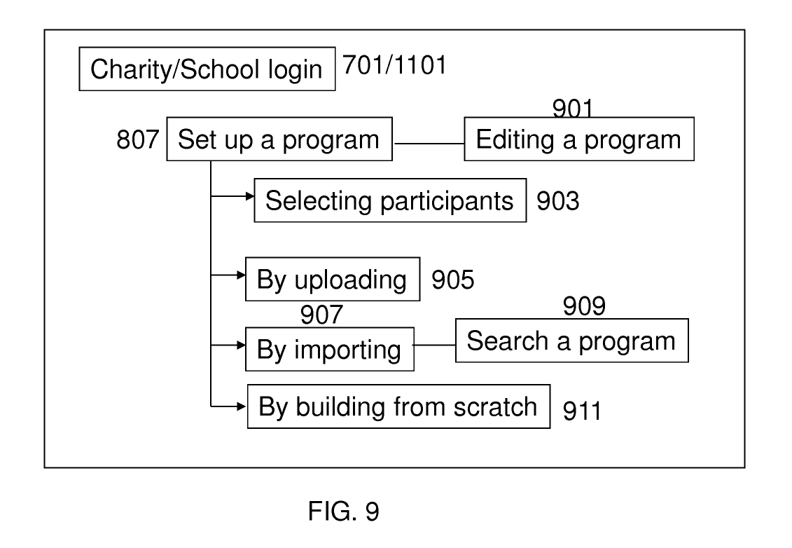

In reference to FIG. 9, an example set up a program component 807 for the charity center or for the school center is shown. By using this function, a registered charity user can edit an existing program (901), and set a program for access by selected participants (903) which only permits the access of authorized users, or as public accessible (default) which allows the program to be searchable and adoptable by other parents or users. A registered charity user can set up a program content by uploading to the system a pre-made program (905), by importing a program from an online web-site (907) using search a program component (909) or by building a program from scratch on the system (911).

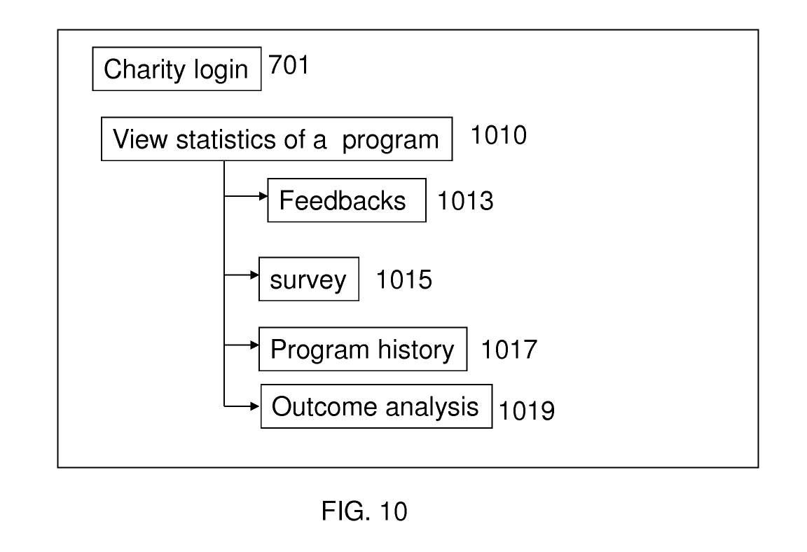

In reference to FIG. 10, an example “view statistics of a program” component 1010 for the charity center is shown. This components provides information about feedback results (1013), survey results (1015), program history (1017) and other outcome analysis of a charity program (1019).

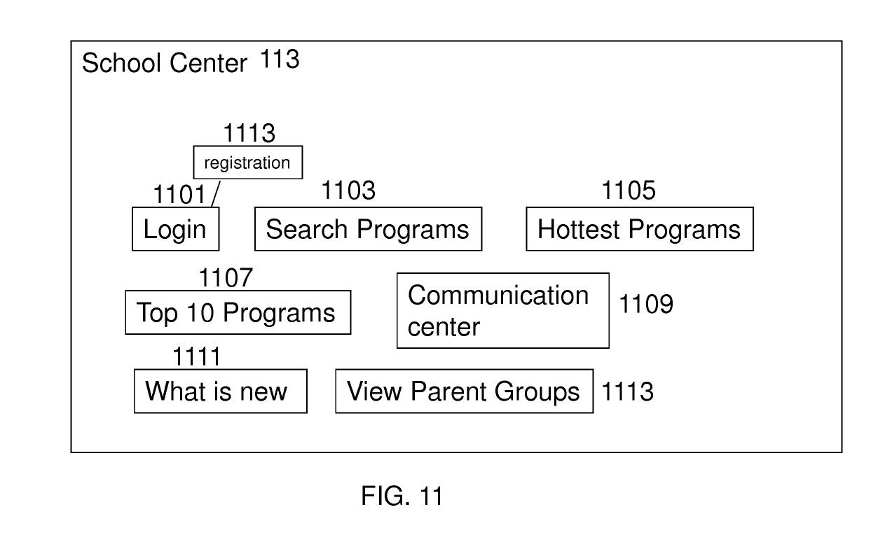

In reference to FIG. 11, an example school center 113 is shown. The school center is for the interaction of schools with the system. School center 113 at least includes several user interfaces, for example: login component 1101, “program search” component 1103, the “most popular programs” component 1105, the “top 10 most popular programs” component 1107, “what is new” button 1111, and “view parent groups” component 1113, and a communication center 1109.

Login component 1101 is also associated with the register button 1115 if a school is not registered, the user will be asked whether to want to be registered. “Program search” component 1103 allows a school to search for content providing programs for review or adopting. The “most popular programs” component 1105 provides a dynamically updated list of most popular programs of the week or over a period of time, according to several different categories or geographic areas. The “top 10 most popular programs” component 1107 provides the most popular top 10 programs at the moment of reviewing. The “view parent groups” component 1113 provides a list of parent groups involved with the school according to various interest or specialties and geographic areas. “What is new” button 1111 provides any news about the school center or any announcement related to a school. The Communication center 1109 allows a school to communicate to other users or groups.

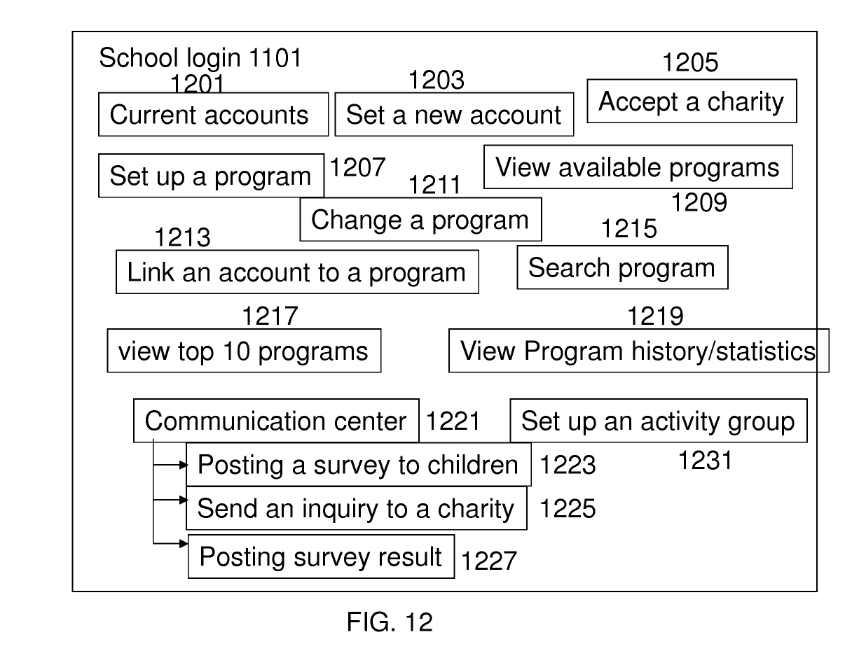

In reference to FIG. 12, an example school login page 1101 interface is shown. A variety of functions are accessible through school login component 1101. For example, my account component 1201, “set a new account” component 1203, “accept a charity” component 1205, “set up a program” component 1207, “link an account to a program” component 1213, “view available programs” component 1209, “change a program” component 1211, “program search” component 1215, “view top 10 programs” component 1217, a communication center 1221, “view program history and statistics” component 1219, and “set up a kid activity group” component 1231.

Through my account component 1201, a registered school can review its current balances of its holding account(s) already set up in the system, to check the statistics of the linked programs. The school could also change or modify the linked programs, or review the account histories. A school user can also set up another account using the “set a new account” component 1203, which allows the school to set up a new holding account for providing financial awards for a kid user to performing a program. A school user can also accept the financial support from a charity by using “accept a charity” component 1205, where a school can participate in providing a program that is supported by a charity and accept a charity's financial support.

A registered school can set up a new program/task for a particular group of kids and providing financial incentives for the kids to perform this program by using the “set up a program” component 1207, and link a program/task to a holding account for automatic financial award management by using the “link an account to a program” component 1213. A registered school may view available programs that are made available by other parents or schools or charities or other content providers by using the “view available programs” component 1209. A registered school can edit or modify a signed up program by using the “change a program” component 1211, where the school may modify the program according to the school's needs or a group's needs or modify the amount or the manner that the kid will get awarded for performing the program.

A registered school user can also search the system or the internet for finding interested content and education materials to adopt into a financial incentive linked program by using the “program search” component 1215, or by using the “view top 10 programs” component 1217 where the top 10 most popular programs at the time and location or in a specific area can be viewed instantly.

A registered school user can use the communication center 1221 to post a survey to a group of students (1223), to send an inquiry to a charity for financial support or suggestions (1225) or posting a survey result (1227). A registered school user reviews a program history and statistics by using the “view program history and statistics” component 1219, and set up a kid activity group by using the “set up a kid group” component 1231.

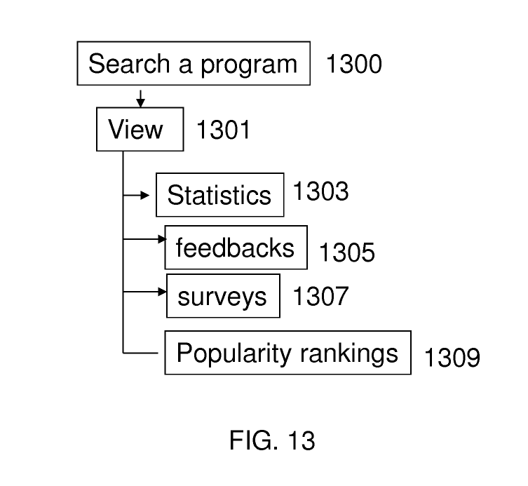

In reference to FIG. 13, an example search a program component 1300 is shown. By using keyword search, the component 1300 will provide a view 1301 in which statistics of a content program is provided (1303), feedbacks (1305), surveys (1307) and popularity rankings (1309) are provided for reviewing.

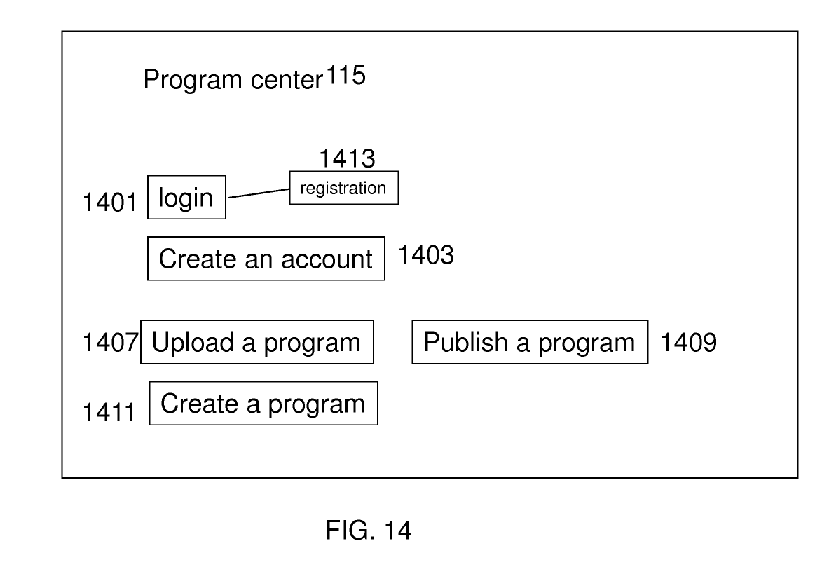

In reference to FIG. 14, an example program center 115 is shown. The program center is for the interaction of other content providing entities with the system. Program center 115 at least includes several user interfaces, for example: login component 1401, “create an account” component 1403, “link an account to a program” component 1405, “upload a program” component 1407, “publish a content program” component 1409, “create a program” component 1411.

Login component 1401 is also associated with the register button 1413 if a program provider is not registered, the user will be asked whether want to be registered.

“Create an account” component 1403 allows a content provider to create an temporary account with system to try out a few features, “link an account to a program” component 1405 allows a holding account to be linked with a program, “upload a program” component 1407 allows a content provider to directly upload its content to the system to be searchable by the users, “publish a content program” component 1409 allows a content provider to publish its original content to be posted to the users on the system without a formal registration, “create a program” component 1411 allows a content provider to create a program on the system and to be posted.

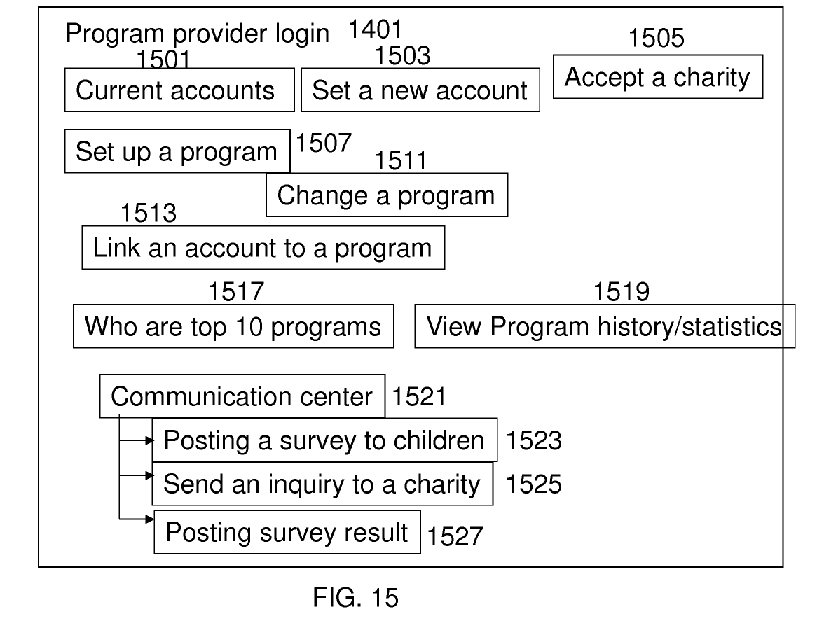

In reference to FIG. 15, an example program provider login page 1401 interface is shown. A variety of functions are accessible through program provider login component 1401. For example, “current accounts” component 1501, “set a new account” component 1503, “accept a charity” component 1505, “set up a program” component 1507, “link an account to a program” component 1513, “change a program” component 1511, “view top 10 programs” component 1517, a communication center 1521, and “view program history and statistics” component 1519.

Through current accounts component 1501, a registered program provider can review its current balances of its holding account(s) already set up in the system, to check the statistics of the linked programs. The program provider could also change or modify the linked programs, or review the account histories. A program provider can also set up another account using the “set a new account” component 1503, which allows the program provider to set up a new holding account for providing financial awards for a kid user to performing a program or for receiving a payment from group users for using the content. A program provider can also accept the financial support from a charity by using “accept a charity” component 1505, where a charity can participate in providing a program that is provided by a content provider.

A registered program provider can set up a new program/task for a particular group of kids and providing financial incentives for the kids to perform this program by using the “set up a program” component 1507, or to receive payment from group users, and link a program/task to a holding account for automatic financial management by using the “link an account to a program” component 1513. A registered program provider can edit or modify a signed up program by using the “change a program” component 1511, where the program provider may modify the program according to the feedbacks.

A registered program provider can view the top 10 post popular programs by using the “view top 10 programs” component 1517 where the top 10 most popular programs at the time and location or in a specific area can be viewed instantly.

A registered program provider can use the communication center 1521 to post a survey to a group of students (1523), to send an inquiry to a charity for financial support or suggestions (1525) or positing a survey result (1527). A registered program provider can review a program history and statistics by using the “view program history and statistics” component 1519.

The above description is intended to provide one preferred embodiment example of the system. It is contemplated and intended that such systems and concepts may be altered and modified by an ordinary person in the art to customize and provide other known and obvious web associated functionalities.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle. The claims as filed are intended to be as comprehensive as possible, and NO subject matter is intentionally relinquished, dedicated, or abandoned.

What is claimed is:

1. A goal-oriented incentive management electronic education system, comprising computer processors that implement interfaces of:
a children center for a child user to set up a first financial holding account having an associated goal; and
a parent center for a parent to set up a second financial holding account and a first program linked with said second financial holding account;
wherein said parent specifies an modifiable first task to be performed in said first program and a first amount of monetary incentive to be awarded upon finishing said first task, wherein once said child finishes said first task, said first amount of monetary incentive is automatically transferred from said second financial holding account to said first financial holding account.

2. The goal-oriented incentive management electronic education system of claim 1, further comprising computer processors that implement interfaces of:
a school center for a school to set up a third financial holding account and a second program linked with said third financial account; and
wherein said school specifies a modifiable second task to be performed in said second program and a second amount of monetary incentive to be awarded upon finishing said second task, wherein once said child finishes said second task, said second amount of monetary incentive is automatically transferred from said third financial holding account to said first financial holding account.

3. The goal-oriented incentive management electronic education system of claim 2, further comprising computer processors that implement interfaces of:
a charity center for a charity to set up a fourth financial holding account and a third program linked with said fourth financial account; and
wherein said charity specifies a modifiable third task to be performed in said third program and a third amount of monetary incentive to be awarded upon finishing said third task, wherein once said child finishes said third task, said amount of monetary incentive is automatically transferred from said fourth financial holding account to said first financial holding account.

4. The goal-oriented incentive management electronic education system of claim 3, further comprising computer processors that implement interfaces of:
a program provider center for a content provider to set up a fifth financial holding account and a fourth program linked with said fifth financial account; and
wherein said content provider specifies a modifiable fourth task to be performed in said fourth program and a fourth amount of monetary payment, wherein once said fourth program is adopted, said fourth amount of money payment is automatically transferred from an account to said fifth financial holding account; or once said child finishes said fourth task, an amount of monetary incentive is automatically transferred from said fifth financial holding account to said first financial holding account, and said system charges a broker fee for each transfer.

5. The goal-oriented incentive management electronic education system of claim 4, further comprising computer processors that implement interfaces of:
a program search component wherein a user can search incentive providing programs by keywords, geographic location, school names, charity names, and/or parent groups.

6. The goal-oriented incentive management electronic education system of claim 4, further comprising computer processors that implement interfaces of:
a program search component wherein a user can search incentive providing programs by keywords, geographic location, school names, charity names, and/or parent groups.

7. The goal-oriented incentive management electronic education system of claim 4, wherein at least one task is specified through adopting a content provided by an online content provider.

8. The goal-oriented incentive management electronic education system of claim 4, wherein at least one task is specified by uploading a pre-defined content.

9. The goal-oriented incentive management electronic education system of claim 4, wherein at least one task is specified by modifying a pre-existing content.

10. The goal-oriented incentive management electronic education system of claim 4, wherein said associated goal is a goal selected from a group of choices consisting of supporting an education, financing a purchase, starting a business, and patenting an innovation, and an early withdrawal triggers a penalty.

11. The goal-oriented incentive management electronic education system of claim 4, wherein said associated goal is a goal specified by said child user, and an early withdrawal triggers a penalty.

12. The goal-oriented incentive management electronic education system of claim 4, wherein the parent or the school or the program provider receives a financial support from the charity by linking said the respective holding account with the holding account of the charity.

13. The goal-oriented incentive management electronic education system of claim 4, wherein statistics of a program is provided.

14. The goal-oriented incentive management electronic education system of claim 4, further comprising computer processors that implement interfaces of:
a communication center for each respective centers wherein feedbacks, surveys, questions and inquiries are communicated.

15. The goal-oriented incentive management electronic education system of claim 4, further comprising computer processors that implement interfaces of:
a first group function for the parent to setup or join a parent group; and
a second group function for the school to setup a kid activity group and to setup a program for the kid activity group.

16. The goal-oriented incentive management electronic education system of claim 4, further comprising computer processors that implement interfaces of:
a view function for dynamically updating a list of most popular programs at a viewing time.

17. The goal-oriented incentive management electronic education system of claim 4, further comprising computer processors that implement interfaces of:
a view function for dynamically updating a list of highest performing kids of a week at a viewing time.

18. The goal-oriented incentive management electronic education system of claim 4, further comprising computer processors that implement interfaces of:
a view function for dynamically updating a list of highest performing kids of a week at a viewing time.

19. The goal-oriented incentive management electronic education system of claim 5, wherein said kid user searches a program on the system and performs said program wherein a money incentive linked with said program is automatically transferred to said first holding account once said kid finishes said program.

20. The goal-oriented incentive management electronic education system of claim 5, wherein said parent or said school or said program provider modifies a program upon reviewing feedbacks.
